(19) United States
(12) Patent Application Publication
(10) Pub. No.: US 2026/0236673 A1
(43) Pub. Date: Aug. 13, 2026

(54) INTELLIGENT SPREADSHEET ANALYZER WITH INTEGRATED IMAGE PROCESSING AND SELF-IMPROVING CONVERSATIONAL AI

(71) Applicant: Genpact USA, Inc., New York, NY (US)

(72) Inventors: Prakash Selvakumar, Bangalore (IN); Tavva Prudhvith, Vijayawada (IN); Karan Ravi, Bangalore (IN); Sreekanth Menon, Bangalore (IN)

(21) Appl. No.: 19/051,911

(22) Filed: Feb. 12, 2025

(51) Int. Cl. G06F 40/18; G06F 16/3329; G06F 40/284; G06V 30/10; G06V 30/413

(52) U.S. Cl. CPC G06F 40/18; G06F 16/33295; G06F 40/284; G06V 30/10; G06V 30/413

(57) ABSTRACT

A method for spreadsheet processing includes receiving an electronic file including a spreadsheet, where the spreadsheet includes at least one embedded image, scanning the spreadsheet to detect the at least one embedded image in the spreadsheet, transforming visual data included in the at least one embedded image into machine-readable text through an optical character recognition process, and reintegrating the machine-readable text into the spreadsheet by merging the machine-readable text extracted from the at least one embedded image and other content in the spreadsheet, to create a unified and structured dataset that integrates available data included in the spreadsheet.

### TECHNICAL FIELD

This disclosure generally relates to computer systems and methods for electronic spreadsheet file processing, and more particularly to techniques for intelligent spreadsheet analyzing with integrated image processing and self-improving conversational AI.

### BACKGROUND

Existing systems in the domain of spreadsheet-based data analysis and question-answering face several notable challenges, which limit their effectiveness and applicability in complex use cases. One major hurdle is the inability to effectively process complex, multi-sheet spreadsheet files containing embedded images and tables, such as Microsoft Excel® spreadsheet files. Current solutions often struggle with recognizing and synthesizing data from such heterogeneous content, leading to incomplete or inaccurate analysis. This shortfall is particularly evident when dealing with embedded visual elements like charts, diagrams, and tables.

Another significant challenge lies in maintaining context and accuracy when addressing follow-up questions about spreadsheet data. Traditional question-answering systems often operate on a query-by-query basis, lacking the ability to track conversational history or dynamically adjust their understanding based on prior interactions. This results in disjointed or repetitive responses, reducing the overall user experience and the utility of such systems in real-world scenarios.

Furthermore, the integration of image recognition with text-based data analysis in spreadsheets is largely underdeveloped. Many spreadsheets include visual data representations, such as charts and infographics, that are critical to fully understanding the data. However, existing tools fail to bridge the gap between visual and textual data, limiting their analytical scope. Similarly, the inability to learn and improve from user feedback in real-time exacerbates these challenges, as systems are unable to adapt to specific user needs or correct errors dynamically, leading to a static and often suboptimal performance.

Handling complex queries that require multi-step reasoning or synthesizing data across different sheets and tables poses another barrier. Such queries demand advanced reasoning capabilities and the ability to correlate disparate data points, a feat beyond the reach of many existing solutions. Moreover, inefficiencies in processing large spreadsheets, particularly those with multiple tables, further impede their utility. These inefficiencies result in slower response times and a higher likelihood of errors, detracting from the user experience and limiting scalability.

Therefore, there is a need for improved electronic spreadsheet data processing.

### SUMMARY

To address the aforementioned shortcomings, a method and system for intelligent spreadsheet analyzing is provided. The method includes receiving an electronic file including a spreadsheet, where the spreadsheet includes at least one embedded image, scanning the spreadsheet to detect the at least one embedded image in the spreadsheet, transforming visual data included in the at least one embedded image into machine-readable text through an optical character recognition process, and reintegrating the machine-readable text into the spreadsheet by merging the machine-readable text extracted from the at least one embedded image and other content in the spreadsheet, to create a unified and structured dataset that integrates available data included in the spreadsheet.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 is a block diagram of an example architecture for an intelligent spreadsheet analyzing system, according to embodiments of the disclosure.

FIG. 2 illustrates example components included in one instance of an intelligent spreadsheet analyzing application, according to embodiments of the disclosure.

FIG. 3 illustrates an example workflow for an intelligent spreadsheet analyzing application, according to embodiments of the disclosure.

FIGS. 4A-4B illustrate a part of another example spreadsheet file before and after processing through the intelligent spreadsheet analyzing application, according to embodiments of the disclosure.

FIGS. 5A-5B illustrate a part of an example spreadsheet file before and after processing through the intelligent spreadsheet analyzing application, according to embodiments of the disclosure.

FIG. 6 is a flow chart of an example method for data extraction from an example spreadsheet file including an embedded image, according to embodiments of the disclosure.

FIG. 7 is a flow chart of an example method for handling a user query, according to embodiments of the disclosure.

FIG. 8 is a block diagram of an example computer for an intelligent spreadsheet analyzing application system, according to embodiments of the disclosure.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for illustration purposes only. One skilled in the art will readily recognize from the following description that alternative embodiments of the structures and methods illustrated herein may be employed without departing from the principles described herein.

To address the aforementioned problems in the existing electronic spreadsheet file processing, the present disclosure provides a method and system for building a comprehensive spreadsheet processing system to address multiple facets of functionality to ensure efficiency and versatility. The system disclosed herein may seamlessly handle multi-sheet spreadsheet files that may include embedded images and tables. This includes advanced parsing algorithms to identify and link relationships across sheets, as well as leveraging technologies like optical character recognition (OCR) to process visual elements such as charts and images. Such capabilities ensure that all aspects of the spreadsheet's content are accessible for detailed analysis, significantly enhancing the system's utility in complex scenarios. Although Microsoft Excel® spreadsheet files are used in connection with illustrating the methods and accompanying systems described herein, it should be appreciated that such methods and systems can accommodate electronic spreadsheet files in various formats, including, without limitation, spreadsheet files defined using the Open Document Format or Extensible Markup Language (XML).

A holistic analysis of spreadsheets necessitates the integration of image recognition and text extraction capabilities. Many spreadsheets contain essential data embedded in charts, diagrams, or other visual elements. The system disclosed herein combines image recognition technologies with text-based data analysis, enabling the system to unify these modalities and generate comprehensive insights. This multi-modal approach bridges the gap between textual and visual data, ensuring that no critical information is overlooked.

To maintain context in user interactions, the disclosed system further integrates advanced natural language processing (NLP) into the spreadsheet file processing. Modern conversational artificial intelligence (AI) models, powered by transformers architecture, may track dialogue history and understand follow-up queries with nuanced context. This ensures that users receive accurate and relevant responses even in multi-turn conversations. By incorporating context-aware NLP, the system may address evolving queries effectively, allowing users to interact naturally and productively with their data.

Incorporating a user feedback mechanism is useful for continuous improvement. A feedback loop allows users to correct inaccuracies or suggest refinements, which the system may use to adapt dynamically. By employing reinforcement learning or active learning techniques, the system disclosed herein may improve its performance over time, becoming increasingly aligned with user expectations and requirements.

Handling complex queries that require multi-step reasoning benefit from the introduction of a reflection mechanism. This includes a self-reflection and iterative thinking mechanism, which prompts the LLM model(s) to go through each prompt through a step-by-step execution and reflection after each step. For example, the model evaluates the outcome of the current step and identifies areas of refinement or better execution. Before proceeding, the model reflects on how to optimize the subsequent step based on the previous results. Using these reflections, the model adjusts its response dynamically to ensure more accuracy and quality as it move forwards. The system disclosed herein includes advanced reasoning frameworks that enable the system to tackle questions demanding deep comprehension and logical progression across datasets based on the reflection mechanism.

Further, implementing a table identification system assists with optimizing query processing. By automatically locating and categorizing tables within spreadsheets, the system disclosed herein may selectively send only relevant tables to the large language model (LLM) for analysis. This targeted approach minimizes processing overhead and ensures that the LLM operates efficiently without being overwhelmed by extraneous data. This selective processing not only improves response times but also enhances the accuracy and relevance of the insights provided. Together, these various tools or mechanisms may transform the spreadsheet processing system disclosed herein into powerful tools for comprehensive data analysis and decision-making.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### Overall System

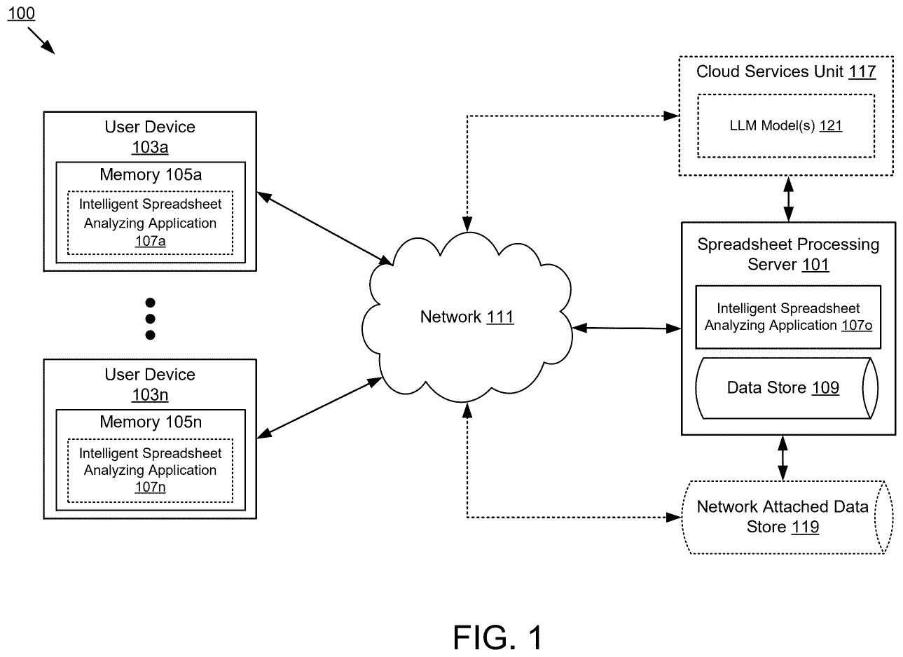

FIG. 1 is a block diagram of an example intelligent spreadsheet analyzing system 100, according to embodiments of the disclosure. The intelligent spreadsheet analyzing system 100 may be a network-based specialized computer environment for processing Excel files with embedded images and for generating responses related to the Excel files when receiving user queries. As noted above, the present disclosure is not limited to Excel file processing but can be applied to any other type of spreadsheet file.

As illustrated in FIG. 1, the intelligent spreadsheet analyzing system 100 may include multiple user devices 103a . . . 103n, which may be specialized computers or other machines that are configured to provide user interfaces for users to interact with the intelligent spreadsheet analyzing application. In one example, the multiple user devices 103a . . . 103n (together or individually referred to as “user device 103”) may upload the Excel files with (or without) embedded images for further processing, such as image-to-text conversion. For this purpose, each user device 103 may optionally include an instance of intelligent spreadsheet analyzing application 107a or 107n stored in memory 105a or 105n associated with the user device, where each instance of intelligent spreadsheet analyzing application may be configured to perform partial or full functions related to image-to-text conversion in Excel files and further handling of user queries related to the processed Excel files.

As will be described in detail later, an intelligent spreadsheet analyzing application 107a or 107n on a user device may be configured to focus more on the user interactions such as receiving user inputs and presenting responses to the users related to the queries, while an instance of intelligent spreadsheet analyzing application 107o included in an spreadsheet processing server 101 is configured to focus more on the image processing, generating responses to the user queries, etc. In some embodiments, a user device 103 may be a part of distributed computing topology, in which a complexity level of a user query may be determined locally, where the determined complexity level is used to determine which response handing unit should be routed to for the user query. Distributed computing topology brings certain early stages of processing to the devices where data is being gathered, rather than relying all on a central location (e.g., spreadsheet processing server 101) that can be thousands of miles away. This is done so that data, especially real-time data, does not suffer latency issues that can affect an intelligent spreadsheet analyzing an application's performance. In addition, the amount of data that needs to be sent to a centralized or cloud-based location is also reduced, which saves the bandwidth required by the intelligent spreadsheet analyzing application.

As described above, the intelligent spreadsheet analyzing system 100 may additionally include a spreadsheet processing server 101. According to some embodiments, the spreadsheet processing server 101 may be configured to have a higher computation power than the user devices 103, and thus some intensive data computations such as image processing may be implemented on server 101 instead, which saves the computation resources and/or reduces the requirement for computation power of each specific user device 103. In some embodiments, spreadsheet processing server 101 may be separately housed from other devices within the intelligent spreadsheet analyzing system 100, such as user devices 103. Alternatively, a spreadsheet processing server 101 may be part of a device or system, e.g., may be integrated with a user device 103 to form an integrated user device of the intelligent spreadsheet analyzing system 100.

In some embodiments, spreadsheet processing server 101 may host a variety of different types of data processing capacities as part of the intelligent spreadsheet analyzing system 100, such as Excel file processing and user query handling as will be described more in detail later. In addition, spreadsheet processing server 101 may also receive a variety of different data from user devices 103, from cloud services unit 117, or other sources. The data may have been obtained or collected from one or more entities (e.g., through one or more user devices) or may have been received as inputs from an external system or device (e.g., through emails, mobile applications, web). In some embodiments, spreadsheet processing server 101 may be configured to perform other functions not described above. For example, spreadsheet processing server 101 may implement certain actions related to data cleaning, database management, etc. In some embodiments, spreadsheet processing server 101 may further implement additional functions unrelated to spreadsheet processing, which are not limited in the present disclosure.

In some embodiments, spreadsheet processing server 101 may communicate with other components of the system 100 through a data communication interface(s). For example, user devices 103 may collect and send data to the spreadsheet processing server 101 to be processed therein, and/or may send signals to the spreadsheet processing server 101 to control different aspects of the data it is processing, among other possibilities. User devices 103 may interact with the spreadsheet processing server 101 through several ways, for example, over one or more networks 111.

Networks 111 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 111 may include a short-range communication channel, such as Bluetooth or a Bluetooth low-energy channel. A wired network may include a wired interface. The wired and/or wireless networks may be implemented using routers, access points, bridges, gateways, or the like, to connect devices in the system 100. The one or more networks 111 may be incorporated entirely within or may include an intranet, an extranet, or a combination thereof. In one embodiment, communications between two or more systems and/or devices may be achieved by a secure communications protocol, such as a secure sockets layer or transport layer security.

In some embodiments, intelligent spreadsheet analyzing system 100 may further include one or more network-attached datastores 119. Network-attached datastore 119 may be configured to store data managed by user devices 103 and/or the spreadsheet processing server 101 in a cloud environment. Network-attached datastore 119 may store a variety of different types of data organized in a variety of different ways and from a variety of different sources. For example, network-attached datastore 119 may store unstructured (e.g., raw) data, such as Excel files with embedded images uploaded by users, and structured data, such as JSON files obtained by the intelligent spreadsheet analyzing application after image-to-text conversion.

In some embodiments, the intelligent spreadsheet analyzing system 100 may additionally include one or more cloud services units 117. A cloud services unit 117 may include a cloud infrastructure system that provides cloud services, such as LLM model(s) 121 for generating responses to user queries based on the user queries received from the user devices and processed Excel files from the spreadsheet processing server 101. In some embodiments, the computers, servers, and/or systems that make up the cloud services unit 117 are different from a user or an organization's own on-premises computers, servers, and/or systems.

In some embodiments, services provided by the cloud services unit 117 may include a host of services that are made available to users of the cloud infrastructure system on demand. For example, the services provided by the cloud services unit 117 may include, but are not limited to, machine learning model development, training, and deployment, messaging, social networking, data processing, image processing, audio-to-voice conversion, video-to-voice conversion, emailing services, intelligent analytics, Software as a service (SaaS), natural language processing, conversational artificial intelligence (AI), or any other services accessible to online users or user devices. In some embodiments, cloud services unit 117 may be utilized by the spreadsheet processing server 101 as a part of the extension of the server, e.g., through a direct connection to the server or through a network-mediated connection.

In some embodiments, services provided by the cloud services unit 117 may dynamically scale to meet the needs of its users. For example, cloud services unit 117 may house one or more intelligent spreadsheet analyzing applications, which may be scaled up and down based on received Excel files and user queries at any time point.

It should be also noted that, while various user devices, server, and services unit are illustrated in the intelligent spreadsheet analyzing system 100 in FIG. 1, it will be appreciated that more or fewer components may be used instead.

### Intelligent Spreadsheet Analyzing Application

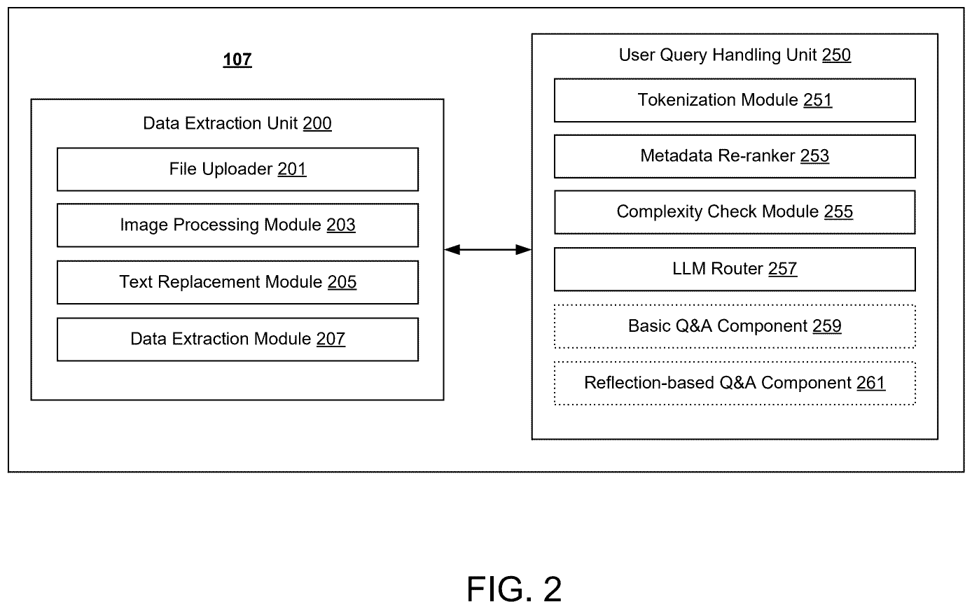

FIG. 2 illustrates example components included in an intelligent spreadsheet analyzing application 107, according to some embodiments of the disclosure. Specifically, as illustrated in the figure, the intelligent spreadsheet analyzing application 107 may include a data extraction unit 200 configured for data extraction from an Excel file including one or more embedded images, and a user query handling unit 250 configured for handling a user query related to the Excel file. The data extraction unit 200 optionally includes a filer upload handler 201, an image processing module 203, a text replacement module 205, and a data extraction module 207, while the user query handing unit 250 may include a tokenization module 251, a metadata re-ranker, complexity check module 255, an LLM router 257, a basic Q&A component 259, and a reflection-based Q&A component 261

Filer upload handler 201 may serve as an entry point to the entire workflow, enabling users to upload Excel files for further processing. Its primary function is to initiate the data extraction pipeline by accepting and validating the input file. In some embodiments, implemented in a Streamlit-based application, the filer upload handler 201 may use the st.file_uploader widget to provide an intuitive drag-and-drop or file-browsing experience. In some embodiments, the filer upload handler may support popular Excel file formats, such as .xlsx and .xls, ensuring broad compatibility.

In some embodiments, the filer uploader 201 may include specific validation and error-handling functions. This includes but is not limited to specific file validation, corruption detection, and error feedback. For file validation, upon uploading, the system may check the file extension to ensure that the uploaded file is a valid Excel format. For correction detection, the libraries like openpyxl or xlrd may be used to confirm file integrity, preventing errors during subsequent processing steps. For user feedback, if a file fails validation, the system may immediately notify the user with detailed error messages and suggestions for resolving the issue. In some embodiments, the filer upload handler 201 may implement additional secure file handling. For example, the uploaded files may be stored in a temporary directory with limited access rights, ensuring user data privacy. In addition, the system may automatically delete temporary files after processing to maintain a secure environment.

The image processing module 203 is responsible for identifying, extracting, and processing embedded images in Excel files. By leveraging OCR capabilities, the image processing module 203 may transform visual data included in an Excel file into machine-readable text, enabling holistic data analysis. This module bridges the gap between image-based information and text-based query processing. The specific process of image processing may include image detection, image extraction, and OCR conversion.

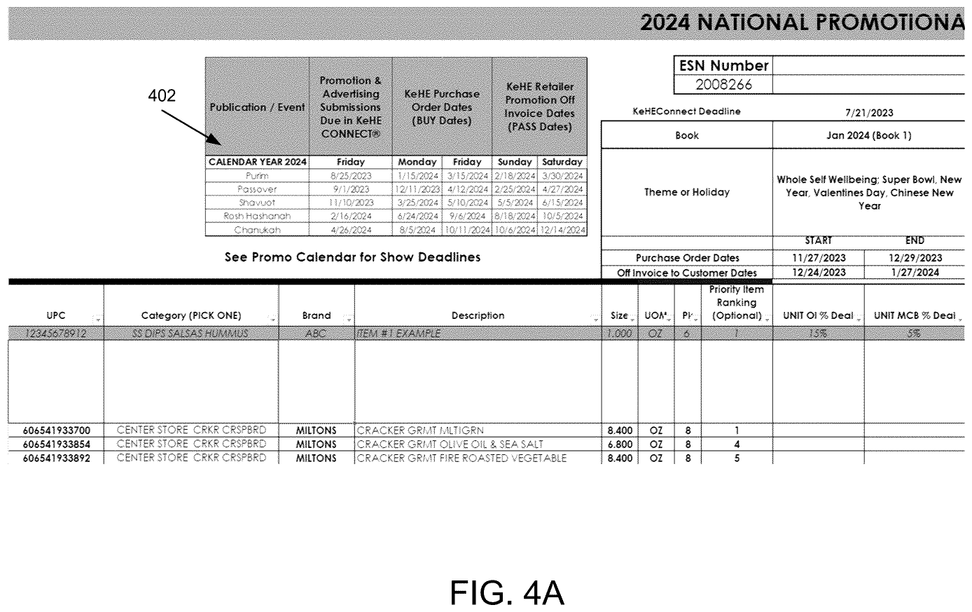

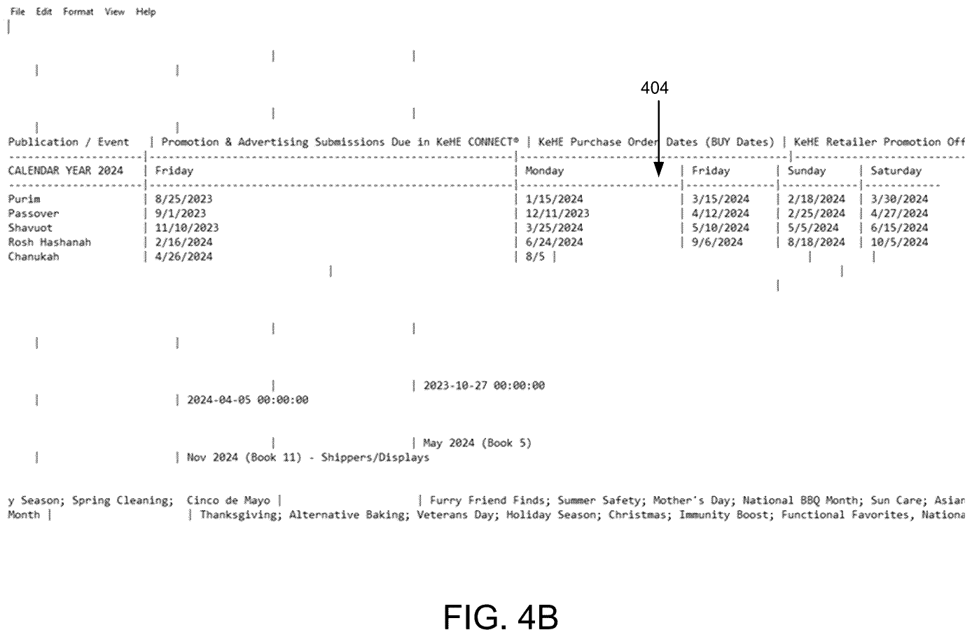

For image detection, the image processing module 203 may scan Excel files to detect embedded images. For example, libraries like openpyxl or xlrd (for legacy files) may be used to scan and extract images from Excel files. In some embodiments, the image processing module 203 may also capture metadata, such as the image's position (cell coordinates) and size, to ensure later reintegration into the data pipeline. FIG. 4A illustrates a part of an example Excel file that includes an image 402 (which includes a table that may be copied and pasted as an image during the spreadsheet preparation).

For image extraction, the identified images may be extracted and saved as separate files in standard formats like .png or .jpg. In some embodiments, the image processing module 203 may be configured to handle various image embedding methods used in Excel (e.g., as objects or background images). For example, openpyxl.drawing.image. Image API may be used to handle embedded image objects. In some embodiments, extracted images are temporarily saved for OCR processing.

With respect to OCR conversion, image processing module 203 may be configured to apply OCR technology to convert the textual content within the extracted images into machine readable and editable and searchable text. In some embodiments, advanced pre-trained models (e.g., Tesseract, EasyOCR, or LLM-integrated OCR systems) may be used to achieve high accuracy in image-to-text conversion. In some embodiments, the image processing module 203 may perform certain pre-processing steps such as noise removal, binarization, and contrast adjustment to enhance OCR results. Specifically, binarization may include a conversion of an image to black-and-white for clearer text recognition, noise removal may include a reduction of background clutter, and contrast adjustment may include an enhancement of faint or blurry text, for example, by using OpenCV. In some embodiments, OCR-generated text may be sent to the LLM for further processing or reintegration into the consolidated dataset as described below. For example, contextual understanding by the LLM may enable it to align image-derived text with adjacent spreadsheet data.

By implementing the image extraction and OCR conversion, the image processing module 203 may allow a conversion of image-based information into a text format compatible with structured data processing. In addition, the process may also ensure that crucial information embedded as images is not overlooked. Further, it also allows user queries to consider data originally stored in visual formats, enriching the analysis.

The text replacement module 205 may be configured for content consolidation or extracted text reintegration, which includes merging extracted text from images and original spreadsheet content. The goal is to create a unified, structured dataset that integrates all available data included in the raw file, ensuring completeness and compatibility with subsequent analysis stages. The specific process may include data integration, structured representation, metadata management, and possible error handling.

Specifically, for data integration, the text replacement module 205 may combine text extracted from the images with remaining data from spreadsheet cells. This may include insertion of OCR text into corresponding cell positions or append it as comments/annotations in a structured format. In some embodiments, the text replacement module 205 may maintain metadata such as cell locations, image origins, and sheet associations for traceability during the data integration. For example, the text replacement module 205 may store positional details for the reintegration of text back into the spreadsheet. FIG. 4B illustrates a part of an example spreadsheet that includes a reintegrated table 404. The table includes reintegrated text converted from the image 402 in FIG. 4A.

In some embodiments, the text replacement module 205 may be configured to implement certain table area resizing and content shifting during data integration. Table area resizing and content shifting involve dynamically adjusting table boundaries and repositioning content within an Excel file to accommodate extracted or inserted data (e.g., OCR-derived text). This process ensures that the spreadsheet remains organized and interpretable without losing context or structural integrity. For example, to resize table boundaries, the text replacement module 205 may expand or contract table areas based on the inclusion of new rows, columns, or annotations, while also maintaining the logical grouping of data within identifiable boundaries (e.g., tables or regions). For content shifting, the text replacement module 205 may adjust the position of surrounding cells, rows, or columns to create space for new content, while also avoiding overwriting or disrupting existing data. In some embodiments, the text replacement module 205 may reserve layout integrity during the data integration process. Briefly, the text replacement module 205 may retain original formatting, such as headers, borders, and merged cells, and also ensure that linked formulas, charts, or pivot tables update dynamically. For example, the text replacement module 205 may use openpyxl.styles to retain formatting, such as bold headers, cell borders, or merged regions, while ensuring that visual elements like charts or conditional formatting rules adjust automatically.

In some embodiments, the text replacement module 205 may distinguish the raw data (from the spreadsheet) and derived data (from OCR), ensuring clarity for downstream processes. For metadata management, the text replacement module 205 may capture additional metadata such as table headers, row indices, and column identifiers.

For structured representation, the text replacement module 205 may structure data in a format ready for tokenization and efficient LLM processing. For example, the consolidated data may be organized into a structured format like a pandas DataFrame or structured numerical and textual analysis or JSON object, including a hierarchical representation of data for use in tokenization and query processing.

For possible error handling, the text replacement module 205 may be configured to identify and resolve conflicts (e.g., overlapping data between OCR text and spreadsheet cells) and/or flag incomplete or inconsistent data for user review. In some embodiments, certain predefined rules may be employed to handle conflicts, such as prioritizing text with higher clarity or prompting users for manual intervention.

The data extraction module 207 may be responsible for transforming spreadsheet content into structured, analyzable formats. This may include three core tasks: pre-processing for initial data handling, post-processing for refining data quality, and full content extraction to save all data in a persistable and shareable format.

Specifically, for pre-processing, the data extraction module 207 may extract content from the spreadsheet row-by-row and convert it into a structured format like pandas DataFrames for analysis and processing. This includes reading data row-by-row from selected Excel files for row-wise text extraction while maintaining the formatting details (e.g., headers, merged cells) for downstream operations. In some embodiments, the pre-processing may also include expanding the space for certain columns that are lengthy to ensure proper alignment and formatting. In some embodiments, the data extraction module 207 may handle special situations in the data extraction. For example, the data extraction module 207 may identify merged cells and expand their values to span corresponding rows/columns. For another example, the data extraction module 207 may resolve embedded formulas by extracting computed values.

For post-processing, its objective is to clean and optimize the extracted data by removing inconsistencies, duplicates, and irrelevant content. For example, the data extraction module 207 may identify and remove rows or columns that are exact duplicates, ensuring uniqueness in the dataset, and may drop rows or columns that are entirely null. Optionally, the data extraction module 207 may impute missing values using statistical methods (e.g., mean, median). In some embodiments, the data extraction module 207 may standardize data types during the optimization process. For example, the data extraction module 207 may convert numerical columns to appropriate formats (e.g., integers, floats), and may normalize text data by stripping whitespace or converting to lowercase. In some embodiments, the data extraction module 207 may check for logical inconsistencies, such as negative values in columns expected to contain only positive data during the post-processing process.

For full content extraction to save all data in a persistable and shareable format, the data extraction module 207 may save the cleaned and structured data as a formatted text file in a database or local storage. For example, the data extraction module 207 may save the full content of the DataFrame into a well-structured text file. Formats like .txt or .json may be used for flexibility. In some embodiments, a “|” symbol may be further added in every cell with spacing to distinctly separate each row for enhanced clarity. In some embodiments, the data extraction module 207 may store the data in a database (e.g., SQLite, MySQL, or MongoDB) for long-term accessibility, and may use a database schema that maps sheet names to tables, with metadata for versioning. In some embodiments, the data extraction module 207 may store metadata such as sheet names, table ranges, and extraction timestamps alongside the content. In some embodiments, the data extraction module 207 may further maintain logs of the extraction process, including steps performed and any errors encountered, for reproducibility.

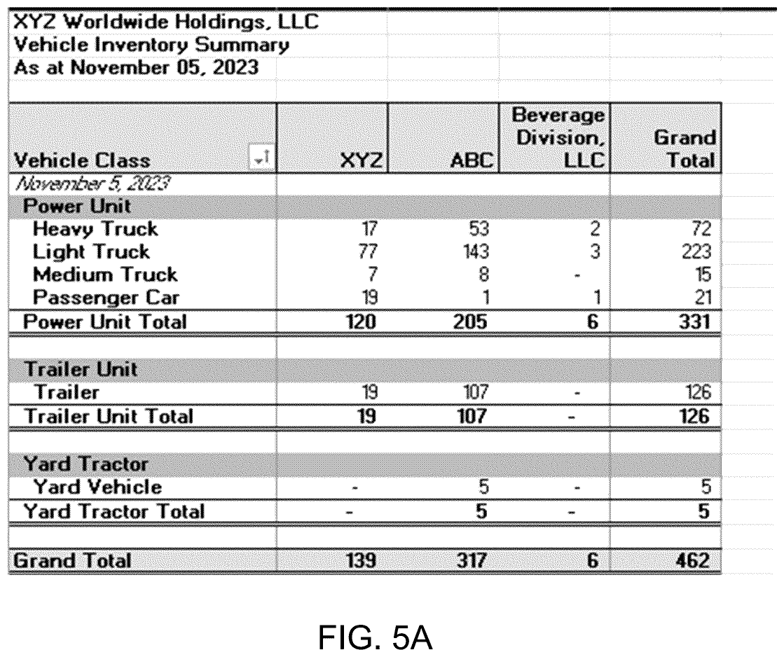

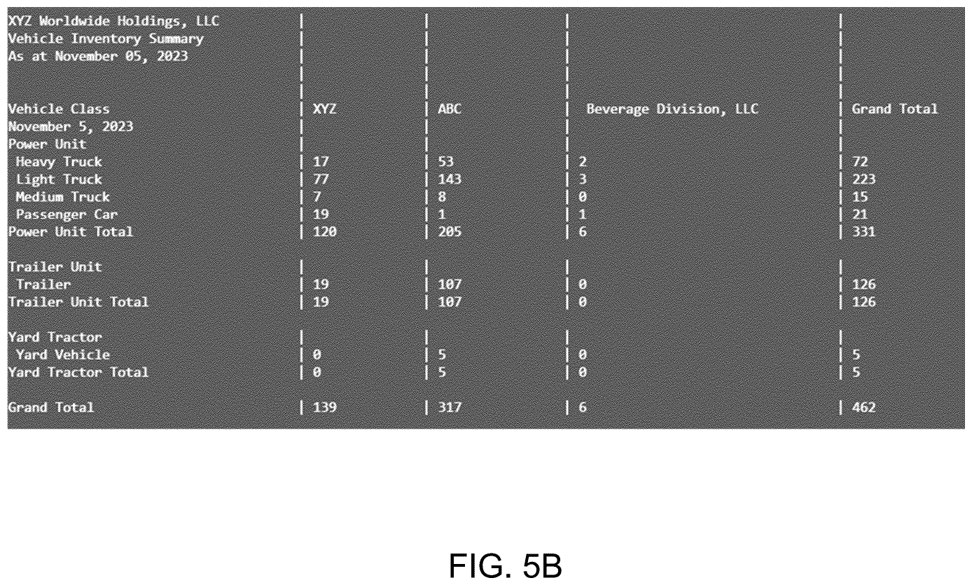

Overall, the data extraction module 207 disclosed herein may convert unstructured spreadsheet content into structured formats like DataFrames, enabling efficient querying and analysis. In addition, post-processing ensures the dataset is clean, unique, and free of redundancies. Furthermore, full content extraction allows for seamless storage and sharing of processed data, enabling integration with other system components or future workflows. By automating data cleaning and storage, the data extraction module 207 ensures the extracted data is ready for immediate use in efficient querying and/or intelligent analysis. FIG. 5A and FIG. 5B illustrate an example table before and after data extraction.

In some embodiments, to facilitate query processing, the extracted data stored in the database may be further tokenized, allowing it to be input into an LLM model for processing.

The tokenization module 251 may be configured to tokenize the consolidated content for LLM processing. For example, through tokenization, the consolidated content from Excel files (including text, numerical data, and metadata) may be broken down into smaller units, such as words, phrases, or symbols, to be input into an LLM model. The tokenization module 251 disclosed herein thus ensures that the data is structured and formatted to be efficiently and effectively processed by the LLM model.

In some embodiments, the tokenization module 251 may format the consolidated content for tokenization. This includes but is not limited to flattening nested data (e.g., converting multi-sheet or hierarchical content into a linear format), labeling (e.g., adding descriptors to content (e.g., “Column: Sales” or “Row: Region”)), and encoding data types (e.g., differentiating text, numbers, dates, and special characters to maintain semantic meaning during processing).

In some embodiments, the tokenization module 251 may implement the tokenization by using libraries that align with the LLM's tokenizer requirements. Commonly used methods include subword tokenization (e.g., Byte Pair Encoding, WordPiece) to efficiently handle diverse inputs. Specifically, the tokenization module 251 may separate content into smaller units, such as words, numbers, or subwords, while preserving the structure to maintain relationships between headers, rows, and metadata. In some embodiments, the tokenization module 251 may convert tokens into numerical IDs based on the model's vocabulary. In some embodiments, the tokenization module 251 may use pre-trained tokenizers (e.g., Hugging Face's Tokenizers, OpenAI API). In some embodiments, if the content exceeds the LLM's token limit, the tokenization module 251 may divide it into manageable chunks while preserving logical groupings (e.g., by sheet or table). In some embodiments, the tokenization module 251 may add delimiters and markers to ensure the LLM understands the context of each token (e.g., table boundaries, headers).

In some embodiments, the tokenization module 251 may implement a selective tokenization. For example, the tokenization module 251 may only tokenize relevant data (e.g., tables or sections directly related to a user query) by using a table identification system (e.g., table identifier) to filter out irrelevant tables. In some embodiments, the tokenization module 251 may compress repetitive or verbose data (e.g., summary statistics) while retaining key information. For example, the tokenization module 251 may replace repeated row labels with indices. In some embodiments, the tokenization module 251 may add contextual tokens to provide additional context to the LLM.

Metadata reranking is another approach to optimizing data for querying by the LLM model. Metadata re-ranker 253 may be configured to reorganize or prioritize metadata based on its relevance or importance for a specific task (e.g., query response generation). In the context of data extraction and analysis from Excel files, metadata refers to the information associated with the data, such as column headers, row labels, table boundaries, and additional contextual details like timestamps or data sources. Re-ranking helps improve the efficiency of querying, filtering, and analysis by making the most relevant pieces of metadata more prominent and accessible. In an automated system processing Excel files, metadata may be used to better organize and access extracted content. Re-ranking may allow for dynamic reordering of metadata based on specific user needs, content relevance, or analysis objectives, thus enhancing the user experience and improving the accuracy of data retrieval.

To implement metadata reranking, the metadata re-ranker 253 disclosed herein may extract relevant metadata from the data source (in this case, an Excel file) and assign an initial importance score or rank based on predefined rules. For example, based on predefined criteria such as column names (e.g., “Date”, “Amount”, and “Name” might be ranked higher than less informative column titles), the metadata re-ranker 253 may first assign a starting rank to each piece of metadata. In some embodiments, once the metadata is extracted and assigned an initial rank, it may be further dynamically re-ranked based on a user's query or the context of another ongoing task. For example, for query-based reranking, the metadata re-ranker 253 may use NLP or machine learning algorithms to analyze user queries and re-rank metadata based on the query's intent. For example, if a user asks about “total sales in 2020,” metadata involving “Date” and “Amount” should be prioritized over other column titles. In some embodiments, the metadata re-ranker 253 may track past user behavior, such as frequent queries or interactions with specific columns, and adjust metadata ranking accordingly. For instance, if a user frequently queries the “Amount” column, its rank will increase over time, ensuring faster access during future queries. In some embodiments, after users provide feedback or query results, the metadata re-ranker 253 may further adjust metadata ranking. In general, positive feedback boosts the importance of certain metadata, while negative feedback demotes it. This feedback loop may continuously optimize the relevance of metadata, improving system performance. In some embodiments, for queries requiring multi-step reasoning, such as calculating sums or averages over specific periods, the metadata re-ranker 253 may prioritize metadata related to time (e.g., “Date” columns) and metrics (e.g., “Amount” columns).

Overall, the metadata reranking ensures that the most relevant metadata is prioritized, reducing query time and improving response accuracy. In addition, behavioral reranking and user feedback allow the system to adapt to individual preferences, providing a more personalized and efficient experience. Furthermore, metadata re-ranking based on user queries or task context helps the system focus on the most relevant information, leading to more meaningful and accurate query results.

The complexity check module 255 may be configured to determine the complexity of a user query. For example, the complexity check module 255 may evaluate the query's structure, length, semantics, and dependencies and assign a complexity level (e.g., Low, Medium, High) based on predefined criteria. For example, by implementing the token count analysis, the complexity check module 255 may count the tokens (words or subwords) in the query to determine the complexity. In general, longer queries with multiple clauses typically indicate higher complexity. In some embodiments, the complexity check module 255 may identify specific keywords that imply complexity, such as “average,” “sum,” “compare,” “trend,” or time references like “last year.” In some embodiments, the complexity check module 255 may further check for logical dependencies (e.g., comparisons, conditions, or nested questions) in determining the complexity. In some embodiments, the complexity check module 255 may further use a lightweight NLP model to parse the query for syntactic or semantic structures, such as nested clauses or multi-part questions when determining the complexity. In some embodiments, the complexity check module 255 may additionally analyze the need for external context, such as references to previous user queries or the need for synthesizing data from multiple sources (e.g., multiple Excel files) when determining the complexity. In some embodiments, the complexity check module 255 may aggregate scores across these dimensions and classify the query. For example, the complexity check module 255 may classify the simple, single-step queries as having low complexity, queries with conditions (e.g., “What are the sales in 2020 for Product A?”) as having the medium complexity, and queries with multi-step reasoning or comparisons (e.g., “Compare sales trends between 2020 and 2021.”) as having the high complexity.

The LLM router 257 may then route a query to the appropriate processing pipeline based on its complexity level. For low complexity queries, the LLM router 257 may directly process with a lightweight LLM or a pre-built rules-based function for quick responses. Exemplary low-complexity queries may include but are not limited to basic arithmetic calculations, single-table lookups, etc. In one specific example, “What are the total sales?” may be considered a simple query, and the LLM router 257 may route it to a lightweight LLM or pre-defined function for basic calculations. For medium complexity queries, the LLM router 257 may use a standard LLM to handle moderate reasoning, single-step context awareness, or single-table operations. Exemplary medium complexity queries may include but are not limited to conditional filtering, and single-column aggregations. In one specific example, “What are the sales in 2020 for Product A?” may be considered as a query with medium complexity, and thus the LLM router 257 may route it to a standard LLM for filtering and aggregation. For high-complexity queries, the LLM router 257 may route them to an advanced LLM or specialized modules capable of multi-step reasoning and complex operations, for example, capable of implementing the reflection mechanism described elsewhere herein. Exemplary high complexity queries may include but are not limited to cross-sheet operations, data synthesis, generating trends, or answering context-heavy questions. In one specific example, “Compare quarterly sales trends for 2020 and 2021 across regions” is a high-complexity query, and thus the LLM router 257 may route it to an advanced LLM with multi-step reasoning and data synthesis.

In some embodiments, instead of classifying the queries into low, medium, and high complexities, a two-level mode may be utilized instead. For example, a query may be classified as a simple query or complex query, and based on the determined complexity, two different types of query response generating models may be used to generate the response, such as the basic Q&A component 259 and the reflection-based Q&A component 261.

For the basic Q&A component 259, it may leverage Google Cloud's Vertex AI (or other similar AI models) for seamless integration with the chatbot interface (which may be the interface for receiving the user query). This setup may allow to handle of user queries directly by routing them to Vertex AI's language model for processing and returning responses. It is designed for straightforward use cases where minimal preprocessing and direct response generation are required. Specifically, in the disclosed system, a user may input a query through a chatbot interface, built using frameworks like Streamlit, Flask, or any conversational UI. The query may be routed by the LLM router 257 directly to Vertex AI without intermediate checks or processing. The Vertex AI's natural language processing capabilities may be used to generate a response based on the input, where the generated response may be sent back to the chatbot interface and displayed to the user. For example, the user query may be “What is the total profit for the North region?” The query may be directly sent to the Vertex AI, which then generates a response using its LLM capabilities. An exemplary answer may be “The total profit for the North region is $200.” In the basic Q&A component 259, the direct routing may ensure minimal setup and faster execution, which makes the response time quicker for simpler queries. In addition, the basic Q&A component 259 disclosed herein may leverage Google Cloud or other similar infrastructures for handling large-scale user interactions.

In some embodiments, the basic Q&A component 259 may include a feedback collection unit that collects feedback provided by users on the quality of the generated response, enabling iterative improvements. In some embodiments, the basic Q&A component 259 may store the collected feedback for future system improvements. For example, negative feedback may be provided to the reflection-based Q&A component 261 in their iterative reflection process, as will be described in detail below.

For the reflection-based Q&A component 261, it may be designed to enhance the accuracy and relevance of responses to complex queries by incorporating an iterative reflection process. This approach involves generating an initial response using the LLM, analyzing the response for quality, and refining it if necessary. The reflection mechanism ensures robust handling of multi-step reasoning, ambiguous queries, or responses requiring additional context. For example, for a query “Summarize the profit trends across all regions for Q1,” the initial query processing may include contextual data retrieval. For example, a generated response may be “The North region shows a profit of $200, and the South region shows a profit of $300.” This response may then trigger a reflection. For example, the reflection-based Q&A component 261 may check the clarity (e.g., was the query fully addressed?), completeness (e.g., were all relevant data points considered?), accuracy (e.g., are there factual or logical errors?) or relevance (e.g., does the response align with the user's intent?). For another, if the query mentions “trends,” and the response lists only static figures, reflection is triggered to refine the answer.

In some embodiments, the reflection-based Q&A component 261 may use a Chain-of-Thought (CoT) reflection mechanism. By breaking down complex queries into intermediate reasoning steps, the CoT-based reflection approach improves the accuracy, context, and completeness of responses. Compared to the reflection mechanism described above, the CoT-based reflection approach is focused on breaking the task into intermediate reasoning steps. It encourages a structured approach where each step logically follows the previous one. Once a step is completed, the model proceeds to the next step without revisiting prior answers or reflecting on mistakes. In other words, the CoT model does not pause to access or correct each step. It assumes each step is correct. The CoT assumes the initial logical reasoning between the intermediate reasoning steps is correct unless explicitly told otherwise. The CoT improves the reasoning by ensuring the thought process is explicit and broken down into smaller, manageable steps. On the other hand, the reflection mechanism described above introduces self-assessment and self-correction into the reasoning process. The model reflects how each well it performs at each step and plans improvements before moving forward. In other words, the process dynamically adjusts based on the identified errors or opportunities for improvement.

In some embodiments, the reflection-based Q&A component 261 may combine both approaches so that these two mechanisms can complement each other. For example, the reflection-based Q&A component 261 may start with CoT prompting to create a structured, step-by-step plan, and then uses reflection mechanism after each step to assess correctness and refine the process.

In some embodiments, the initial and follow-up responses may be consolidated into a cohesive, refined output by the reflection-based Q&A component 261. For example, one refined output may be “The North region shows a profit of $ 200, a 10% increase compared to Q4. The South region shows a profit of $300, a 15% increase compared to Q4.” In some embodiments, the reflection-based Q&A component 261 may validate the final response for consistency and accuracy before being displayed. In some embodiments, the reflection-based Q&A component 261 may also include a feedback collection unit for collecting feedback from users, so as to improve later processing by the reflection-based Q&A component 261.

Overall, the reflection-based Q&A component 261 may improve the accuracy through the iterative refinement, which is especially useful for multi-step reasoning and ambiguous or multi-part questions. In addition, the reflection-based Q&A component 261 may dynamically adjust to user needs and query complexities, and thus more precise and comprehensive responses lead to better user engagement.

It should be noted that, while FIG. 2 illustrates some specific components included in an intelligent spreadsheet analyzing application 107, the disclosed system is not limited to these components but may include additional components not described above.

### Example Architecture

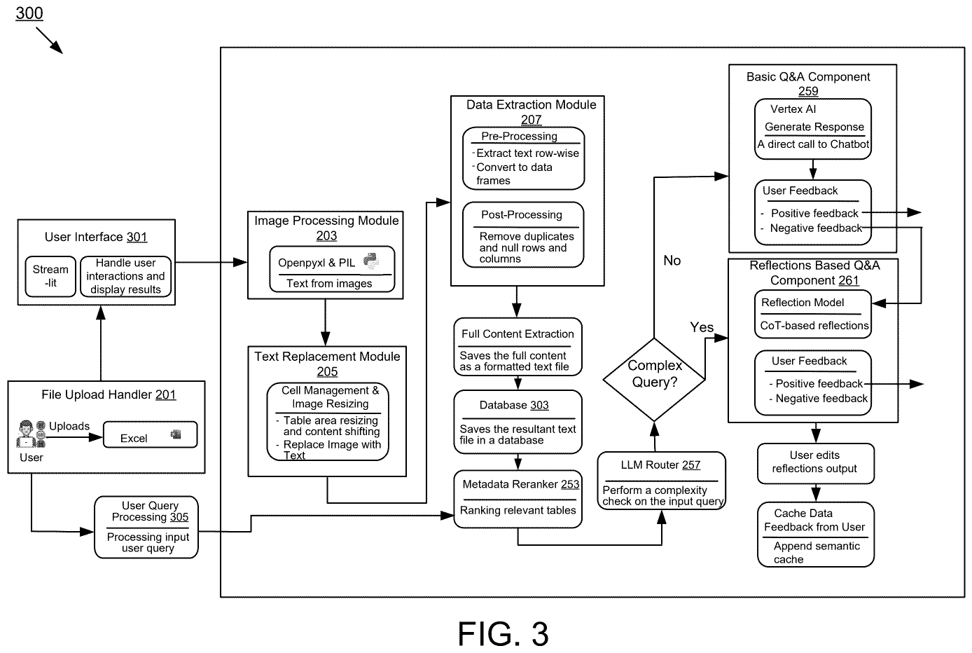

Referring now to FIG. 3, an example workflow 300 for implementing the intelligent spreadsheet analyzing application is further described. Specifically, workflow 300 may begin with a user uploading an Excel file through a user-friendly interface 301. The file upload handler 201 may handle the specific file upload, and the interface 301 may be configured in a way to ensure accessibility and convenience for users of varying technical expertise (e.g., Streamlit). Interface 301 may support files in standard Excel formats (e.g., .xlsx, .xls), ensuring compatibility with commonly used data structures. For example, the interface may be a Streamlit interface that uses st.file_uploader to accept Excel files in .xlsx or .xls format. In some embodiments, the file upload handler 201 may validate file integrity using libraries like openpyxl or xlrd. In some embodiments, the file upload handler 201 may further check for upload errors (e.g., incorrect format, corrupt files) and notify users with descriptive error messages.

Once the Excel file is uploaded, the system may extract the names of sheets from the Excel file and present a list of available sheets within the Excel file to the user for selection. The user selects one or more sheets to process, allowing for focused analysis and reducing unnecessary computation on irrelevant data. This step enhances the system's efficiency and ensures user-defined customization. If not selection is received, all content in the Excel file may be processed by default. For sheet listing, libraries such as openpyxl or pandas may be used to enumerate sheet names. For dynamic display, the user may select one or multiple sheets using a multi-select widget in Streamlit, which dynamically adjusts to the file's contents.

Following the user selection, the image processing module 203 may process the selected sheets to identify and extract embedded images. For image identification, the image processing module 203 may use advanced parsing algorithms to scan the selected sheets to locate images, including charts, diagrams, and other visual elements. For example, the image processing module 203 may identify images using Excel-specific APIs like openpyxl.drawing.image or xlrd for older Excel versions. In addition, the position metadata (e.g., cell coordinates) may be recorded for later reintegration.

For image extraction, the identified images may be extracted and saved as separate files for further processing. For example, the extracted images may be saved as .png or .jpg files in a temporary directory, and image processing libraries like Pillow or cv2 may be used by the image processing module 203 for handling image formats and resolutions. After image extraction, OCR may be performed on the extracted images to convert visual content into machine-readable text, as described earlier. This text is then stored for reintegration into the spreadsheet. For example, the image processing module 203 may use OCR tools like Tesseract to extract text from images. In some embodiments, preprocessing techniques such as binarization, noise removal, and resizing may be performed beforehand to ensure OCR accuracy.

After processing images, the text replacement module 205 may consolidate all available content for further analysis. This may include text reintegration and table area resizing and content shifting. Specifically, for text reintegration, extracted text from images may be inserted back into the spreadsheet in appropriate locations or as metadata annotations. For example, OCR-generated text may be added as metadata in corresponding cells or as comments using openpyxl. This ensures a unified dataset that includes both textual and visual information.

For structured data extraction, the data extraction module 207 may extract all content from the spreadsheet, including reintegrated text and original data, and organize the extracted data into a structured format (e.g., JSON or pandas DataFrame). For example, the spreadsheet's structured data (rows, columns, and tables) may be extracted into a tabular format using pandas. DataFrame. In some embodiments, a JSON object may be created to represent the entire content, including text, tables, and reintegrated image data. This structure then serves as the foundation for subsequent analysis, including user query processing. In some embodiments, the extracted and formatted data file may be saved in a database 303 for later retrieval in query processing.

In some embodiments, to optimize query processing, the system may identify and organize tables within the consolidated content. This may include table detection and metadata generation. Specifically, for table detection, one or more algorithms may be configured to scan the structured content to locate distinct tables based on formatting, spacing, and cell grouping patterns. For example, the system may use heuristics such as merged cells, row gaps, and header patterns to identify tables. In addition, libraries like pandas may be used to analyze cell formats and contents to define table boundaries. In metadata generation, for each identified table, the system may generate metadata, including but not limited to its location (sheet name and cell range) within the sheet, dimensions, and header details. This metadata is crucial for selectively targeting relevant tables during analysis. In some embodiments, the generated metadata may be stored in a separate JSON file for quick reference during querying.

In the next, the consolidated content may undergo tokenization to prepare it for processing by an LLM. This may include content segmentation and tokenization, as described earlier. Specifically, for content segmentation, text and numerical data may be segmented into logical units, such as paragraphs, rows, cells, or cell clusters, based on the structure of the spreadsheet. In some embodiments, predefined rules may be used for the segmentation process. For token generation, the segmented content may be converted into tokens compatible with LLMs. Tokenization ensures that data is efficiently and accurately processed by the model, accounting for token limits and relevance. For example, tokenization may be performed using libraries like transformers from Hugging Face, ensuring compatibility with LLMs. In some embodiments, content may be chunked to respect token limits, with strategies like truncation or prioritization applied to maintain relevance. After tokenization, the consolidated content is then ready to be processed by an LLM model for handling the user query.

With respect to the user query processing 305, the system may start with a same or different user interface 301. For example, the user may interact with the system through a chatbot-style interface integrated into Streamlit. The interface 301 may include an input box for natural language queries with options to clarify or refine the question. In some embodiments, a query history display allows users to track previous interactions. This may help the user to generate a more meaningful query based on the previous interaction, or simplify the query input by selecting one of the previous queries.

In some embodiments, based on the received user query, the metadata may be reranked, as described earlier. For example, the metadata re-ranker 253 in the system may improve the efficiency of querying, filtering, and analysis by making the most relevant pieces of metadata more prominent and accessible through the re-ranking process. In some embodiments, the metadata re-ranking may include re-ranking of relevant tables. In some embodiments, re-ranking may also include re-rank certain parts such as certain columns in a specific table. In general, by implementing the metadata re-ranking process, the metadata re-ranker 253 may help the system focus on the most relevant information, leading to more meaningful and accurate query results.

In some embodiments, the user query may be also checked for the query complexity once received by the system. For example, the complexity check module 255 may evaluate the query's structure, length, semantics, and dependencies and assign a complexity level based on predefined criteria. Based on the determined complexity, the LLM router 257 may then route the query to the corresponding query handling unit for generating a response. For example, in the illustrated embodiment in FIG. 3, the query may be classified as a complex query or not. For a query classified as “not complex” by the complexity check module 255, the query may be routed to a basis Q&A component 259. For a query classified as “complex” by the complexity check module 255, the query may be routed to a reflection-based Q&A component 261.

The basic Q&A component 259 may handle the user query directly by routing it to Vertex AI's language model for processing and returning responses. It is designed for straightforward use cases where minimal preprocessing and direct response generation are required. On the other hand, the reflection-based Q&A component 261 may enhance the accuracy and relevance of responses to complex queries by incorporating an iterative reflection process. This approach involves generating an initial response using the LLM, analyzing the response for quality, and refining it if necessary, as described earlier.

In some embodiments, as illustrated in FIG. 3, either the basic Q&A component 259 or the reflection-based Q&A component 261 may implement a feedback mechanism to improve the query response generation. For example, the disclosed system may include a user interface configured for user edits of output responses or reflections. The received feedback may allow the generated response to be refined for improved accuracy. In some embodiments, the disclosed system may cache data feedback from the user. Appending a semantic cache into the Q&A component 259 or 261 optimizes query handling by storing and reusing responses to frequently asked or semantically similar queries. For example, this approach reduces computational costs and latency by avoiding redundant calls to Vertex AI for queries that match or closely resemble previously processed ones.

### Example Methods

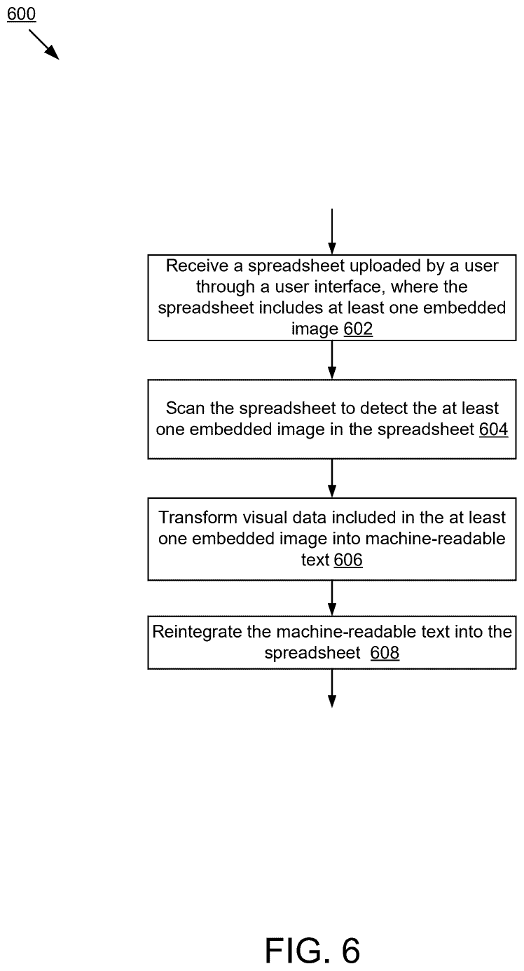

Referring now to FIG. 6, an example method 600 for data extraction from an Excel file including an embedded image is provided. Method 600 starts at step 602 with receiving a spreadsheet uploaded by a user through a user interface, where the spreadsheet includes at least one embedded image. The embedded image may contain certain text or non-text objects that can provide insightful information. The spreadsheet may also include tables in a standard format. At step 604, the spreadsheet is scanned to detect at least one embedded image in the spreadsheet. Libraries like openpyxl or xlrd (for legacy files) may be used to scan and extract images from Excel files. At step 606, the visual data included in the at least one embedded image is transformed into machine-readable text. An example technique used for this purpose is OCR, while other techniques are also possible. At step 608, the machine-readable text is reintegrated into the spreadsheet by merging the machine-readable text extracted from the at least one embedded image and other original content in the spreadsheet, to create a unified and structured dataset that integrates available data included in the spreadsheet.

In some embodiments, scanning the spreadsheet to detect the at least one embedded image in the spreadsheet further includes capturing metadata associated with the at least one embedded image, where the metadata includes the at least one embedded image's position and size information in the spreadsheet, which is used for reintegrating the machine-readable text into the spreadsheet.

In some embodiments, merging the machine-readable text extracted from the at least one embedded image and other original content in the spreadsheet includes table area resizing and content shifting to dynamically adjust table boundaries and reposition content within the spreadsheet to accommodate the machine-readable text extracted from the at least one embedded image.

In some embodiments, the unified and structured dataset is created in a format ready for tokenization and large language model (LLM) processing. In some embodiments, method 600 further includes tokenizing consolidated content in the unified and structured dataset for LLM processing, where tokenizing consolidated content in the unified and structured dataset includes separating content into smaller units while preserving a structure to maintain relationships between headers, rows, and metadata included in the spreadsheet. In some embodiments, tokenizing consolidated content in the unified and structured dataset includes adding contextual tokens to provide additional context for LLM processing.

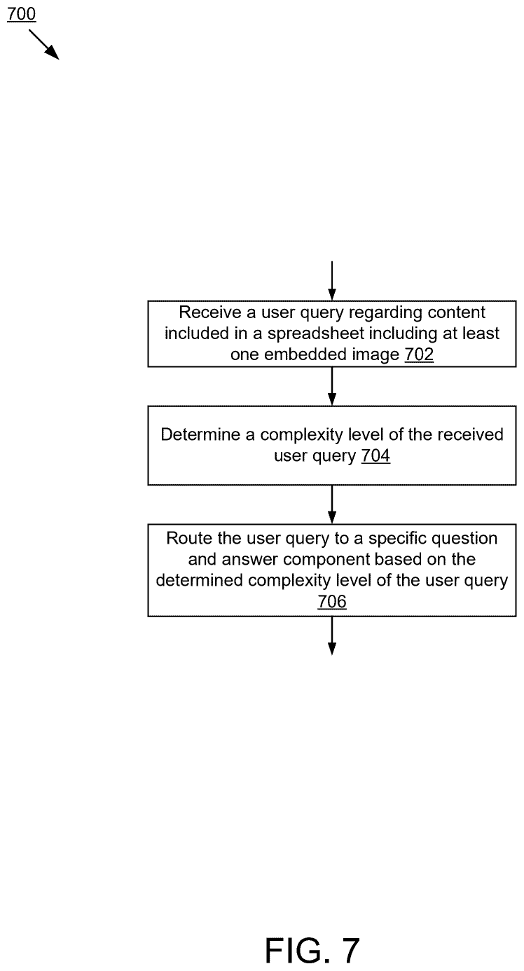

Referring now to FIG. 7, an example method 700 for handling a user query related to the processed Excel file is further provided. The method 700 starts at step 702 with receiving a user query regarding content included in a spreadsheet including at least one embedded image. The spreadsheet may be a same or different one than the one discussed in FIG. 6, or even one that does not include an embedded image, to which the method 700 disclosed herein still applies. The method 700 continues at step 704 to determine the complexity level of the received user query. The query's structure, length, semantics, and dependencies may be used in the evaluation, a complexity level (e.g., Complex or Not Complex) may be then assigned based on predefined criteria. At step 706, the user query is routed to a specific Q&A component based on the determined complexity level of the user query.

In some embodiments, the Q&A component may be one of a basic Q&A component or reflection-based Q&A component described earlier. The reflection-based Q&A component may include a reflection unit configured to parse an initial response identify one or more gaps or inconsistencies for the initial response, and plan improvements in the identified one or more of the gap and inconsistency before moving to a next step. In some embodiments, method 700 further includes re-ranking metadata based on its relevance or importance for the received user query. In some embodiments, methods 600 and 700 may include additional steps or processes described in FIGS. 2-3, details of which are not repeated here.

The spreadsheet processing system and method described above show advantages when compared to other existing spreadsheet processing systems. The disclosed system offers a transformative approach to Excel file analysis, providing comprehensive processing capabilities that extend beyond traditional methods. By enabling the handling of multi-sheet Excel files with embedded images, the system ensures that all aspects of complex data structures are accessible for thorough analysis. This capability is particularly valuable for professionals managing intricate datasets, such as data analysts or researchers, who often work with multifaceted spreadsheets.

An important advantage of the disclosed system lies in its ability to maintain context in conversations, achieved through advanced NLP techniques. By understanding the context of follow-up questions and multi-turn dialogues, the system disclosed herein may deliver responses that are relevant and coherent, significantly enhancing user interactions. This feature is especially useful in scenarios requiring prolonged and iterative data exploration, as it allows users to engage naturally without losing track of prior queries.

The integration of image recognition with text-based analysis is another noteworthy advantage, enabling the system disclosed herein to interpret and synthesize data from charts, diagrams, and text seamlessly. This holistic approach ensures that no critical information, whether visual or textual, is missed during the analysis. Moreover, the incorporation of real-time user feedback mechanisms allows the system disclosed herein to learn and adapt dynamically, leading to continuous performance improvements and better alignment with user needs over time.

In addition, the reflection mechanism for handling complex queries introduces a sophisticated reasoning framework that decomposes intricate questions into manageable steps. This ensures accurate and insightful responses to queries requiring multi-step logical processing or data synthesis. Coupled with a user-friendly interface that combines file upload, data processing, and chatbot interaction, the system becomes accessible and intuitive, making advanced data analysis approachable even for non-experts. Furthermore, efficiency and accuracy are bolstered by selective table identification, which sends only relevant tables to the language model, minimizing processing time while maximizing relevance and precision.

### Implementing Device

In some embodiments, the various intelligent spreadsheet analyzing application systems disclosed herein may be implemented on a computing system with access to a hard disc or remote storage, as further described in detail below.

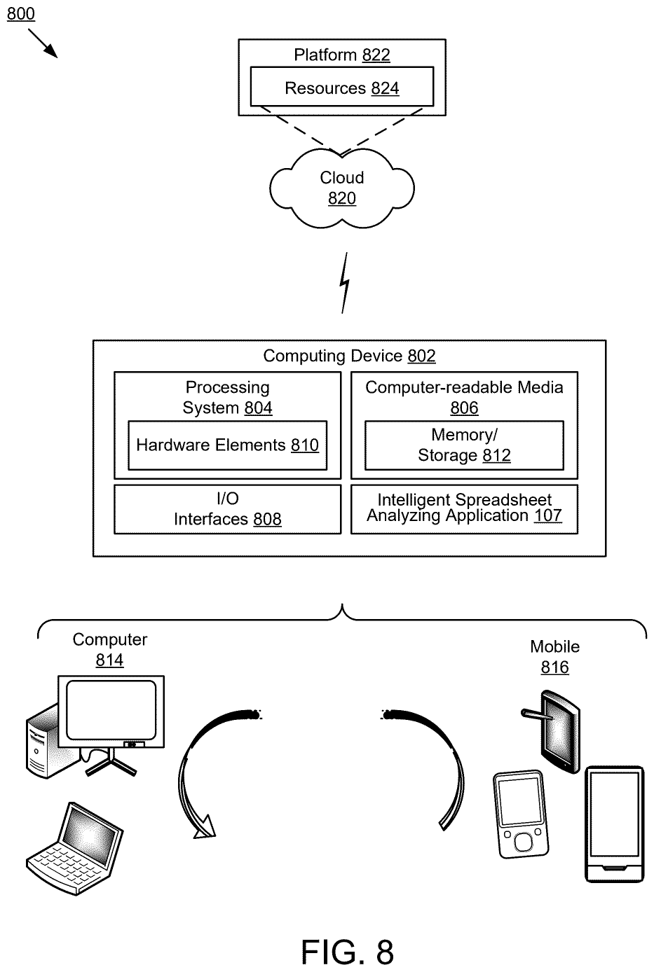

FIG. 8 illustrates an example system 800 that, generally, includes an example computing device 802 that is representative of one or more computing systems and/or devices that may implement the various techniques described herein. The computing device 802 may be, for example, a user device 103, a cloud services unit 117, or a spreadsheet processing server 101 as shown in FIG. 1, an on-chip system embedded in a device (e.g., IoT), and/or any other suitable computing device or computing system.

The example computing device 802 as illustrated includes a processing system 804, one or more computer-readable media 806, and one or more I/O interfaces 808 that are communicatively coupled, one to another. Although not shown, the computing device 802 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of the functionality to perform one or more operations using hardware. Accordingly, the processing system 804 is illustrated as including hardware element 810 that may be configured as processors, functional blocks, and so forth. This may include implementation in hardware as an application-specific integrated circuit (ASIC) or other logic devices formed using one or more semiconductors. The hardware elements 810 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable media 806 is illustrated as including memory/storage 812. The memory/storage 812 represents memory/storage capacity associated with one or more computer-readable media. The memory/storage 812 may include volatile media (such as random-access memory (RAM)) and/or nonvolatile media (such as read-only memory (ROM), Flash memory, optical disks, magnetic disks, and so forth). The memory/storage 812 may include fixed media (e.g., RAM, ROM, a fixed hard drive, and so on) as well as removable media, e.g., Flash memory, a removable hard drive, an optical disc, and so forth. The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 810 and computer-readable media 806 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of an engine that is executable by the computing device 802 as software may be achieved at least partially in hardware, e.g., through the use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for providing one or more device-specific AI engines, which can be further personalized. This improves the performance of an AI engine not only due to its compatibility with specific device constraints but also due to its personalized output.

In the example system 800, multiple devices are interconnected through a central computing device. The central computing device may be local to multiple devices or may be located remotely from the multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 802 may assume a variety of different configurations, such as for computer 814 and mobile 816 uses, and for many enterprise use, IoT user, and many other uses not illustrated in FIG. 8. Each of these configurations includes devices that may have generally different constructs and capabilities, and thus the computing device 802 may be configured according to one or more of the different device classes. For instance, the computing device 802 may be implemented as the computer 814 family of a device that includes a personal computer, desktop computer, multi-screen computer, laptop computer, netbook, and so on. The computing device 802 may also be implemented as the mobile 816 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 802 and are not limited to the specific examples of the techniques described herein. This is illustrated through the inclusion of an intelligent spreadsheet analyzing application 107 on the computing device 802, where the intelligent spreadsheet analyzing application 107 may include different units or modules as illustrated in FIGS. 1-3. The functionality represented by the intelligent spreadsheet analyzing application 107 and other modules/applications may also be implemented all or in part through the use of a distributed system, such as over a “cloud” 820 via a platform 822 as described below.

The cloud 820 includes and/or is representative of platform 822 for resources 824. The platform 822 abstracts the underlying functionality of hardware (e.g., servers) and software resources of the cloud 820. Resources 824 may include applications and/or data that can be utilized while computer processing is executed on servers that are remote from the computing device 802. Resources 824 can also include services provided over the internet and/or through a subscriber network, such as a cellular or Wi-Fi network.

The platform 822 may abstract resources and functions to connect the computing device 802 with other computing devices 814 or 816. The platform 822 may also serve to abstract the scaling of resources to provide a corresponding level of scale to encountered demand for the resources 824 that are implemented via platform 822. Accordingly, in an interconnected device implementation, the implementation functionality described herein may be distributed throughout system 800. For example, the functionality may be implemented in part on the computing device 802 as well as via the platform 822 which abstracts the functionality of the cloud 820.

### Additional Considerations

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method for spreadsheet processing, comprising:
receiving an electronic file including a spreadsheet, wherein the spreadsheet includes at least one embedded image;
scanning the spreadsheet to detect the at least one embedded image in the spreadsheet;
transforming visual data included in the at least one embedded image into machine-readable text through an optical character recognition process; and
reintegrating the machine-readable text into the spreadsheet by merging the machine-readable text extracted from the at least one embedded image and other content in the spreadsheet, to create a unified and structured dataset that integrates available data included in the spreadsheet.

2. The computer-implemented method of claim 1, wherein scanning the spreadsheet to detect the at least one embedded image in the spreadsheet further comprises capturing metadata associated with the at least one embedded image.

3. The computer-implemented method of claim 2, wherein the metadata includes the at least one embedded image's position and size information in the spreadsheet, and wherein the reintegrating the machine-readable text into the spreadsheet is based at least in part of the position and size information.

4. The computer-implemented method of claim 1, wherein merging the machine-readable text extracted from the at least one embedded image and other content in the spreadsheet comprises table area resizing and content shifting to dynamically adjust table boundaries and reposition content within the spreadsheet to accommodate the machine-readable text extracted from the at least one embedded image.

5. The computer-implemented method of claim 1, wherein the unified and structured dataset is created in a format ready for tokenization and large language model (LLM) processing.

6. The computer-implemented method of claim 1, further comprising:
tokenizing consolidated content in the unified and structured dataset for LLM processing.

7. The computer-implemented method of claim 6, wherein tokenizing consolidated content in the unified and structured dataset comprises separating content into smaller units while preserving a structure to maintain relationships between headers, rows, and metadata included in the spreadsheet.

8. The computer-implemented method of claim 7, wherein tokenizing consolidated content in the unified and structured dataset comprises adding contextual tokens to provide additional context for LLM processing.

9. The computer-implemented method of claim 1, further comprising:
receiving a user query regarding content included in the spreadsheet;
determining a complexity level of the received user query; and
routing the user query to a specific question and answer (Q&A) component based on the determined complexity level of the user query.

10. The computer-implemented method of claim 9, wherein the Q&A component is one of a basic Q&A component and a reflection-based Q&A component.

11. The computer-implemented method of claim 10, wherein the reflection-based Q&A component includes a reflection unit configured to parse an initial response and identify one or more of a gap and an inconsistency for the initial response.

12. The computer-implemented method of claim 11, wherein the reflection-based Q&A component is configured to plan improvements in the identified one or more of the gap and inconsistency before moving to a next step.

13. The computer-implemented method of claim 9, further comprising:
re-ranking metadata based on its relevance or importance for the received user query.

14. A system for spreadsheet processing, comprising:
a processor; and
a memory, coupled to the processor, configured to store executable instructions that, when executed by the processor, cause the processor to perform operations comprising:
receiving an electronic file including a spreadsheet, wherein the spreadsheet includes at least one embedded image;
scanning the spreadsheet to detect the at least one embedded image in the spreadsheet;
transforming visual data included in the at least one embedded image into machine-readable text through an optical character recognition process; and
reintegrating the machine-readable text into the spreadsheet by merging the machine-readable text extracted from the at least one embedded image and other content in the spreadsheet, to create a unified and structured dataset that integrates available data included in the spreadsheet.

15. The system of claim 14, wherein scanning the spreadsheet to detect the at least one embedded image in the spreadsheet further comprises capturing metadata associated with the at least one embedded image.

16. The system of claim 15, wherein the metadata includes the at least one embedded image's position and size information in the spreadsheet, and wherein the reintegrating the machine-readable text into the spreadsheet is based at least in part of the position and size information.

17. The system of claim 14, wherein merging the machine-readable text extracted from the at least one embedded image and other content in the spreadsheet comprises table area resizing and content shifting to dynamically adjust table boundaries and reposition content within the spreadsheet to accommodate the machine-readable text extracted from the at least one embedded image.

18. The system of claim 14, wherein the unified and structured dataset is created in a in a format ready for tokenization and LLM processing.

19. The system of claim 14, wherein the operations further comprise:
tokenizing consolidated content in the unified and structured dataset for LLM processing.

20. The system of claim 14, wherein the operations further comprise:
receiving a user query regarding content included in the spreadsheet;
determining a complexity level of the received user query; and
routing the user query to a specific Q&A component based on the determined complexity level of the user query.
